(19) United States
(12) Patent Application Publication
(10) Pub. No.: US 2006/0114268 A1
(43) Pub. Date: Jun. 1, 2006

(54) Composite works of art that incorporate video images within a painting and methods for creating such works

(76) Inventor: Benjamin Marxen, Brooklyn, NY (US)

Correspondence Address: COHEN, PONTANI, LIEBERMAN & PAVANE, 551 FIFTH AVENUE, SUITE 1210, NEW YORK, NY, 10176, US

(21) Appl. No.: 11/001,163

(22) Filed: Dec. 1, 2004

(51) Int. Cl. G09G 5/00

(52) U.S. Cl. 345/629

(57) ABSTRACT

A composite work of art is comprised of a painted portion and a video portion. One or more video monitors are positioned such that images displayed thereon are visible through unpainted portions of a surface surrounding said monitors upon which a painting has been rendered. When viewed, the images displayed on the monitors and the painted images form a single, integral work with the video images providing a kinetic element to an otherwise static, traditionally rendered painting. The subject of the video images displayed on the monitors may relate to the creation of the painting or to its subject matter. The video images can be prerecorded or live action video.

### FIELD OF THE INVENTION

The invention is in the field of art, video and mixed media and methods of creating composite works of art comprising a video portion and a portion produced by traditional means such as painting or drawing.

### BACKGROUND OF THE INVENTION

The impulse to create works of art is one of the characteristics that distinguish men from other animals. Since the dawn of civilization, certain creative individuals have utilized the materials and technology at hand to create objects whose primary, if not sole, function was to be aesthetically pleasing. Artists always have been among the first people in any society to explore the possible uses of newly created materials and technology. The development of television and computer technology in the latter half of the twentieth century resulted in an unprecedented explosion in the variety of ways that artists could make use of technology.

Notwithstanding the seemingly unlimited possibilities offered by modem computer technology and the Internet, artists generally have utilized computers in one of two basic ways: either as a tool to create an artistic template on a substrate which the artist then completes using the traditional artistic techniques of painting, drawing, sculpture, etc.; or as both the tool to create the template and the medium in which the artwork is realized. Surprisingly, however, although thousands of artists use computers either as an artistic medium or as a tool to assist them in creating a work of art using a traditional medium such as oil paint, heretofore no artists appear to have created works of art in which video images are displayed on a flat screen video monitor incorporated into an otherwise traditionally rendered oil painting as an integral part of a single work of art.

### SUMMARY OF THE INVENTION

An object of the present invention is to provide a method for creating a work of art that is a composite of an oil painting and video images displayed on one or more video monitors incorporated within the boundaries of the painting.

A further object of the present invention is to provide a method for producing a composite work of art in which video images that illuminate the process by which the finished work was created comprise a portion of the work.

A still further object of the present invention is to provide a method for producing a composite work of art in which video images contribute a narrative or temporal component into an otherwise static traditional work of fine art.

Another object of the present invention is to provide a method of combining traditional painting techniques and video technology to form a cohesive single artwork that contains moving video elements incorporated into a single flat painted surface.

To achieve the above-described objects of the invention, in one embodiment a surface is prepared to be painted or drawn upon and attached to a frame. Holes are created in the surface of the size and shape of one or more video monitors, which are then attached to the frame such that the surface and the video monitors comprise a single continuous surface on which the work of art will be produced. The artist paints on the surface, leaving at least portions of the video monitors exposed. When the finished painting is displayed, prerecorded video images stored in a computer or DVD are displayed on the monitors, thereby incorporating the contents of the videos into the painting.

In another embodiment, the surface to which the paint is applied is transparent and the video monitors are attached to the frame behind the surface such that the finished artwork comprises video images visible through unpainted portions of the surface.

### BRIEF DESCRIPTION OF THE DRAWINGS

FIG. 1 shows a frontal view of one embodiment of a work of art made according to the invention.

FIG. 2 shows a rear view of one embodiment of a work of art made according to the invention.

FIG. 3(a)-3(d) show how the portion of a composite work of art made according to the invention that will be displayed by videotape might appear over a period of time.

FIG. 4(a)-4(d) shows how the area surrounding the video monitor displaying a previously recorded image is painted according to the invention to create an integral work of art comprising painted and video images.

FIG. 5(a)-5(d) shows how a work of art made according to the invention might appear at different times.

FIG. 6(a)-6(c) shows how another embodiment of a work of art made according to the invention might appear at different times.

### DETAILED DESCRIPTION OF PREFERRED EMBODIMENTS THE INVENTION

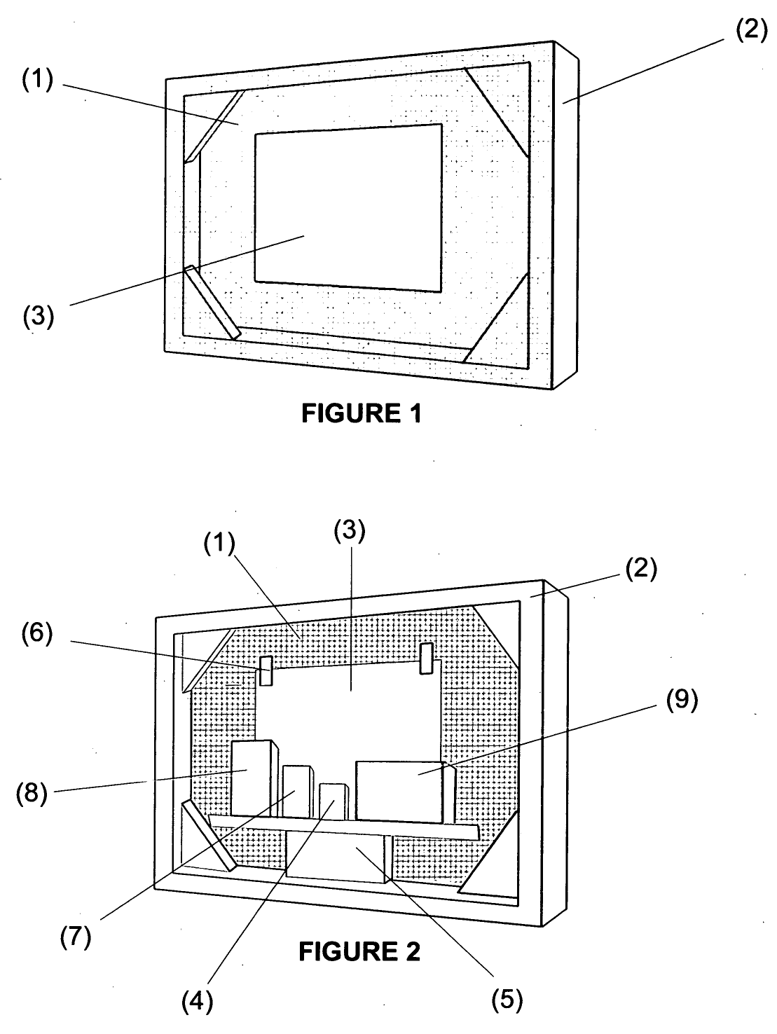

Referring to FIGS. 1 and 2, a transparent piece of Plexiglas™ (1) is permanently attached to a frame (2). The frame can be constructed from any solid material such as aluminum, wood or plastic and can be of any shape or size. Similarly, in lieu of Plexiglas™, any transparent solid material such as glass or plastic can be attached to the frame. Flat screen video monitor (3) and its associated electronic components (4) (extracted from any housing in which they originally had been enclosed) are mounted within the frame behind the Plexiglas™ on shelf (5) and secured in position by adhesive tape (6). The monitor and its components should be mounted in such a way that they can easily be removed if repair or replacement is required at some time in the future. Monitor (3) is then operatively connected to videoprocessor (7) (by wires not shown) which in turn is then operatively connected to a DVD player (8) or computer (not shown) that will be the source of video images transmitted by way of the video processor to the monitor. The monitor, videoprocessor and DVD player all are connected to power source (9) (e.g. a battery pack) or by wires to an external power source (not shown).

It will be appreciated that, while the embodiment illustrated employs a videoprocessor and DVD player connected by wires to the video monitor, the video source also could be a wireless video receiver mounted within the frame to receive video signals transmitted from an external source for display on the monitor.

### Creation of the Composite Work of Art

Once the physical components of the artwork have been assembled as described above, it is necessary to plot out which areas on the surface of the Plexiglas™ are to be painted and which areas are to be left open to reveal the video displayed on the monitor. Once the piece has been plotted out, the Plexiglas™ surface can be treated in ways well-known in the art in order to enhance its paintability, e.g. with gesso or Bins™ primer.

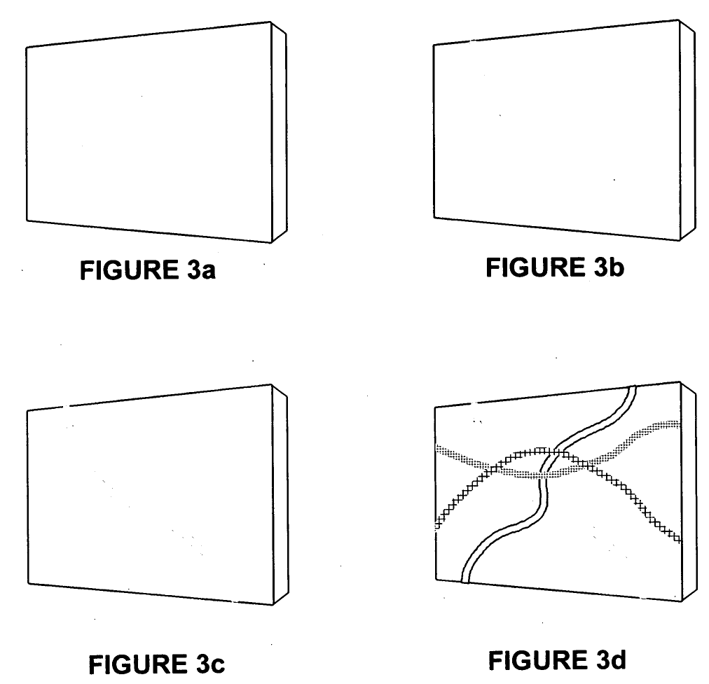

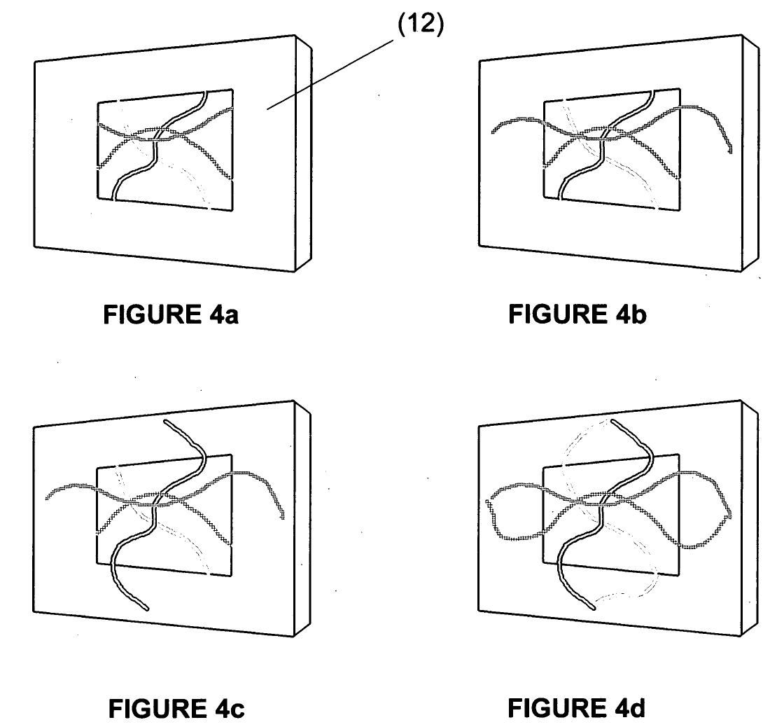

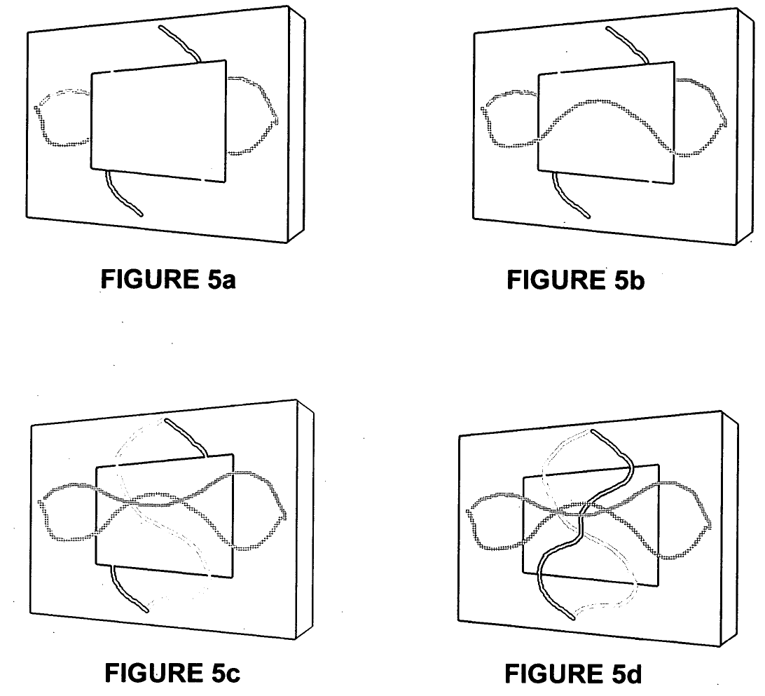

In a preferred embodiment, a board or canvas of the same size as the video monitor is prepared to be painted upon as described above. The artist then begins painting the board, stopping periodically to photograph it with a digital camera or video recorder. FIGS. 3(a)-3(d) illustrate photographs recording the creation of the painting on the board. When the painting on the board is complete, the digital photos are organized using commercially available software well-known in the art to create a time lapse video loop depicting the creation of the painting. The time lapse video loop is then stored in the computer for later transmission to the video monitor or, alternatively, burned into a more portable storage medium such as a CD or DVD. This video loop is then continuously displayed on the monitor mounted behind the plexiglass as shown in FIGS. 1 and 2. The prepared Plexiglass™ (12) surrounding the video monitor (which no longer is transparent) is then painted such that the video images seamlessly integrate with images painted on the Plexiglass™ as shown in FIGS. 4(a)-4(d). When the work is complete, as shown in FIGS. 5(a)-5(d), the central video portion changes over time, yet always in the context of the complete composite work.

In another embodiment of the invention, a flat board of the size and shape of a video monitor is prepared to be painted upon as previously described. The image to be shown on the monitor is then painted with photographs being taken periodically the which will subsequently be organized into a video depicting creation of that image. When the image is complete, the painted board is mounted behind the plexiglass in the same place where the video monitor ultimately will be located. The unpainted part of the plexiglass surrounding the painted board is then prepared and painted upon. This enables the artist to create multiple composite works of art where the borders of the video image seamlessly meet the painted portion of the plexiglass forming a single, unified image without the need to purchase expensive video monitors. When the work is displayed or sold, the board is removed and the video monitor is mounted in the same position.

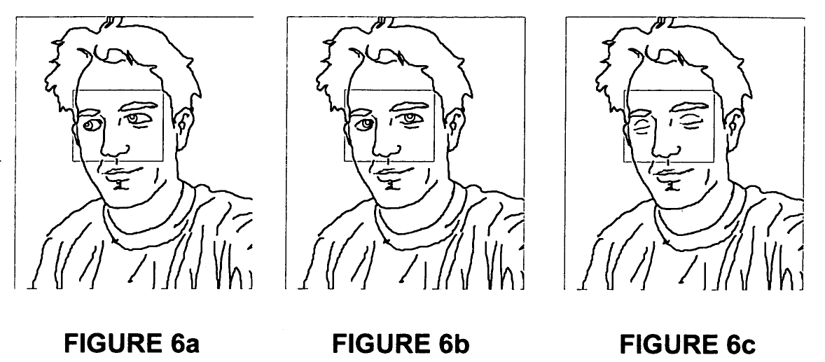

When the finished artwork is displayed, the video loop continuously repeats on the video monitor, resulting in a painting in which the painted part is static while the part supplied by the video monitor continually changes over time. An example of the effect achieved is illustrated in FIGS. 5(a)-5(d) and 6(a)-6(c). It will be appreciated that the video component of the artwork can be subject to various modifications, for example through the use of variable speeds of display, running the video loop forward or backward, altering the colours of the video display from those of the paint actually applied, or by applying any of the numerous visual effects that can be achieved through commercially available image processing or artistic computer programs well-known in the art.

Although the above described method depicted in FIGS. 3-5 illustrated the creation of abstract painting, the claimed methods can equally be applied to create figurative works. FIGS. 6(a)-6(c) illustrate the above-described method used to create a traditional portrait in which the subject's eyes are portrayed in the video portion of the work, enabling them to move and blink. In this embodiment, photographs of multiple paintings of the eyes looking in different directions or blinking are assembled into a video like cels in an animated film. Alternatively, a video of the eyes of the subject showing the actual eye movements over time can be substituted for a video showing different painted images of the subject's eyes.

In another embodiment of the invention, the Plexiglas™ can be replaced by a solid substrate such as a wooden board which is then prepared, painted and photographed as previously described. Upon completion of the painting, one or more sections of the surface are cut away and one or more video monitors are mounted within the frame so that their screens are visible through the open spaces. Preferably, the surface of the substrate and the monitors form a flat, continuous surface. If desired, paint can be applied directly to the monitors' screens to enhance the continuity between the painted and video components of the art work. When more than one monitor is used, each monitor may display the same images, related images varying in a predesignated manner such as forward and backward in time or in the color palette of the display, or unrelated images selected to produce a desired effect. Multiple monitor effects also can be achieved using the screen within a screen technology presently available on many televisions.

Another embodiment of the invention, can be produced by extracting a single frame from a pre-recorded video sequence. The single frame is then used as a reference for the larger scale painting within which the original video will be displayed. For example, the video might depict a scene in which a subject moves about in a room and then sits in a chair while the painted portion of the artwork depicts the other parts of the room and part of the chair.

In another embodiment of the invention, the pre-recorded video loop can be replaced by live action video components obtained from one or more digital video cameras connected to one or more video monitors. In one example of such an embodiment, a video camera is positioned in such a way that the viewer will be viewing him or herself on a video monitor while viewing the painting. In another embodiment, a mirror is are mounted on the frame in lieu of one of the video monitors, providing the viewer with both video and mirror images of him or herself and the surrounding environment that are incorporated as part of the painting.

It will be appreciated that, although all of the above-described embodiments refer to works of art on a scale suitable for display on the wall of an average home or museum, the claimed methods also may be employed on a much larger scale. It should further be appreciated that, although the embodiments of the invention described are produced using oil paint, the methods described also could be practiced using other media well-known to artists such as acrylic, pastels, crayon, graphite, collage, etc. Another variation possible would be to create the video portion of the work using computer software rather than a camera. The invention also could be practiced by painting directly on a video monitor. Having illustrated the principles of the invention by the above-described embodiments, those embodiments can be modified in arrangement and detail in numerous ways without departing from the principles of the invention. I claim as my invention all such embodiments and variations thereof, and their equivalents, as come within the true spirit and scope of the following claims.

What is claimed is:

1. A method of producing a single composite artwork comprising a painted portion and a video portion comprising the steps of:
constructing a frame,
attaching a transparent surface on which to apply paint to said frame,
attaching a video monitor to said frame behind said surface,
applying paint to said surface such that at least part of said video monitor is visible through the layer of paint,
creating a video, and
displaying said video on said video monitor,
thereby producing said single composite artwork.

2. The method of claim 1 in which the video depicts the creation of at least a part of the painted portion of the work.

3. The method of claim 1 in which a plurality of video monitors are attached to said frame.

4. The method of claim 3 wherein said monitors display different images.

5. The method of claim 1 wherein a video camera is connected to the video monitor which displays live action video obtained from said video camera.

6. The method of claim 2 wherein the video images are displayed at variable speeds or with variable colors or otherwise modified using computer software.

7. A method of producing a composite work of art comprising the steps of:
applying paint to a surface,
cutting one or more holes out of said surface,
attaching one or more video monitors to said surface such that their screens are visible through said holes, and
displaying on said monitors video images,
thereby producing a composite work of art including both painted and video components.

8. The method of claim 7 wherein said video images are stored in a computer attached to said video monitor.

9. The method of claim 7 wherein said video images are stored on a DVD or other portable storage medium.

10. The method of claim 7 wherein the subject of said video images is the creation of said work of art.

11. The method of claim 7 wherein at least some of the video images are created or modified using computer software.

12. The method of claim 7 wherein a video camera feeds live action video to at least one of said video monitors.

13. The method of claim 10 wherein at least some of the video images displayed are modified such that the painted portion of the artwork displayed on the video differs from the painting as it was originally produced.

14. The method of claim 7 wherein one or more mirrors is mounted upon said surface.

15. A work of art comprising:
a flat surface which has been painted upon, and
one or more video monitors positioned so that video images displayed thereon are visible through unpainted areas in said flat surface.

16. The work of art of claim 15 wherein the video images are visible through holes cut in the flat surface.

17. The work of art of claim 15 wherein the flat surface is transparent before the paint is applied.

18. The work of art of claim 15 wherein the video images relate to the creation of the work of art.

19. The work of art of claim 15 wherein different video images are displayed on different monitors.

20. The work of art of claim 15 wherein a video camera recording live action video supplies the video images to at least one of the monitors.
